(19) United States
(12) Patent Application Publication
(10) Pub. No.: US 2013/0198653 A1
(43) Pub. Date: Aug. 1, 2013

(54) METHOD OF DISPLAYING INPUT DURING A COLLABORATION SESSION AND INTERACTIVE BOARD EMPLOYING SAME

(71) Applicant: SMART Technologies ULC, Calgary (CA)

(72) Inventors: EDWARD TSE, Calgary (CA); MIN XIN, Calgary (CA); ANDREW LEUNG, Calgary (CA); MICHAEL BOYLE, Calgary (CA); TACO VAN IEPEREN, Calgary (CA)

(73) Assignee: SMART TECHNOLOGIES ULC, Calgary (CA)

(21) Appl. No.: 13/738,355

(22) Filed: Jan. 10, 2013

Related U.S. Application Data
(60) Provisional application No. 61/585,237, filed on Jan. 11, 2012.

(51) Int. Cl. G06F 3/0484

(52) U.S. Cl. CPC G06F 3/0484
USPC 715/751

(57) ABSTRACT

A method of displaying input during a collaboration session, comprises providing a canvas for receiving input from at least one participant using a computing device joined to the collaboration session; and displaying the canvas at one of a plurality of discrete zoom levels on a display associated with the computing device.

### CROSS-REFERENCE TO RELATED APPLICATION

This application claims the benefit of U.S. Provisional Application No. 61/585,237 to Tse et al. filed on Jan. 11, 2012, entitled “Method of Displaying Input During a Collaboration Session and Interactive Board Employing Same”, the entire disclosure of which is incorporated herein by reference.

### FIELD OF THE INVENTION

The present invention relates generally to collaboration, and in particular to a method of displaying input during a collaboration session and an interactive board employing the same.

### BACKGROUND OF THE INVENTION

Interactive input systems that allow users to inject input (e.g., digital ink, mouse events etc.) into an application program using an active pointer (e.g., a pointer that emits light, sound, or other signal), a passive pointer (e.g., a finger, cylinder or other suitable object) or other suitable input devices such as for example, a mouse, or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001, all assigned to SMART Technologies of ULC of Calgary, Alberta, Canada, assignee of the subject application, the entire disclosures of which are incorporated by reference; touch systems comprising touch panels employing electromagnetic, capacitive, acoustic or other technologies to register pointer input; tablet and laptop personal computers (PCs); smartphones; personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital imaging devices at its corners. The digital imaging devices have overlapping fields of view that encompass and look generally across the touch surface. The digital imaging devices acquire images looking across the touch surface from different vantages and generate image data. Image data acquired by the digital imaging devices is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

Multi-touch interactive input systems that receive and process input from multiple pointers using machine vision are also known. One such type of multi-touch interactive input system exploits the well-known optical phenomenon of frustrated total internal reflection (FTIR). According to the general principles of FTIR, the total internal reflection (TIR) of light traveling through an optical waveguide is frustrated when an object such as a pointer touches the waveguide surface, due to a change in the index of refraction of the waveguide, causing some light to escape from the touch point. In such a multi-touch interactive input system, the machine vision system captures images including the point(s) of escaped light, and processes the images to identify the touch position on the waveguide surface based on the point(s) of escaped light for use as input to application programs.

A user interacting with an interactive input system may need to display information at different zoom levels to improve readability or comprehension of the information. Zoomable user interfaces have been considered. For example, U.S. Pat. No. 7,707,503 to Good et al. discloses a method in which a structure, such as a hierarchy, of presentation information is provided. The presentation information may include slides, text labels and graphical elements. The presentation information is laid out in zoomable space based on the structure. A path may be created based on the hierarchy and may be a sequence of the presentation information for a slide show. In one embodiment, a method to connect different slides of a presentation in a hierarchical structure is described. The method generally allows a presenter to start the slide show with a high level concept, and then gradually zoom into details of the high level concept by following the structure.

Several Internet-based “online” map applications also use zoomable user interfaces to present visualization at various levels of detail to a user.

However, while known zoomable user interfaces provide various approaches for presentation and user interaction with information at various zoom levels, such approaches generally provide limited functionality for management of digital ink input across the various zoom levels.

It is therefore an object to provide a novel method of displaying input during a collaboration session and a novel interactive board employing the same.

### SUMMARY OF THE INVENTION

In one aspect there is provided a method of displaying input during a collaboration session, comprising providing a canvas for receiving input from at least one participant using a computing device joined to the collaboration session; and displaying the canvas at one of a plurality of discrete zoom levels on a display associated with the computing device.

In one embodiment, the input is touch input in the form of digital ink. In one embodiment, the method further comprises displaying new digital ink input on the canvas at a fixed line thickness with respect to the display associated with the computing device, regardless of the current zoom level of the canvas.

In another embodiment, the method further comprises displaying the canvas at another of the discrete zoom levels in response to a zoom command. In one embodiment, the zoom command is invoked in response to an input zoom gesture. In another embodiment, zooming of the canvas is displayed according to a continuous zoom level scale during the zoom command. In a further embodiment, the method further comprises adjusting the line thickness of digital ink displayed in the canvas to the another discrete zoom level.

In one embodiment, the method further comprises displaying the canvas at another of the discrete zoom levels in response to a digital ink selection command. In one embodiment, the digital ink selection command is invoked in response to an input double-tapping gesture. In one embodiment, the another discrete zoom level is a zoom level at which the selected digital ink was input onto the canvas. In another embodiment, the method further comprises searching for a saved favourite view of the canvas that is near a current view of the canvas and displaying the canvas such that it is centered on an average center position of the current view and the favourite view.

In one embodiment, the displaying further comprises displaying at least one view of the canvas at a respective discrete zoom level. In one embodiment, the at least one view comprises a plurality of views, the method further comprising displaying the plurality of views of the canvas simultaneously on the display associated with the computing device.

In one embodiment, the collaboration session runs on a remote host server. In another embodiment, the collaboration session is accessible via an Internet browser application running on a computing device in communication with the remote host server. In one embodiment, the displaying comprises displaying within an Internet browser application window on the display associated with the computing device.

In another aspect there is provided an interactive board configured to communicate with a collaboration application running a collaboration session providing a canvas for receiving input from participants, the interactive board being configured to, during the collaboration session receive input from at least one of the participants; and display the canvas at one of a plurality of discrete zoom levels.

### BRIEF DESCRIPTION OF THE DRAWINGS

Embodiments will now be described more fully with reference to the accompanying drawings in which:

FIG. 1 is a perspective view of an interactive input system;

FIG. 2 is a top plan view of an operating environment of the interactive input system of FIG. 1;

FIG. 3 is an Internet browser application window displayed by the interactive input system of FIG. 1 upon joining a collaboration session provided by a collaboration application, and showing a canvas;

FIG. 4 is a graphical plot of canvas zoom level;

FIG. 5 is a view of the canvas of FIG. 3, showing digital ink thereon at different zoom levels;

FIGS. 6A and 6B are views of the canvas of FIG. 3, before and after execution of a zoom level snap command, respectively;

FIG. 7 is a flowchart showing steps of a canvas view update process utilized by the collaboration application;

FIG. 8 is a flowchart showing steps of a canvas view snap process utilized by the collaboration application;

FIGS. 9A to 9D are views of a privacy settings dialogue box presented by the collaboration application, showing different privacy settings;

FIG. 10 is the Internet browser application window of FIG. 3, updated to show a split screen display area;

FIG. 11 is the Internet browser application window of FIG. 3, updated to show a mark search dialogue view;

FIG. 12 is the Internet browser application window of FIG. 3, updated to show a dwell time view;

FIG. 13 is the Internet browser application window of FIG. 3, updated to show an input contribution view;

FIG. 14 is the Internet browser application window of FIG. 3, updated to show a queue area; and

FIG. 15 is the Internet browser application window of FIG. 14, updated to show a user interface dialog box.

### DETAILED DESCRIPTION OF THE EMBODIMENTS

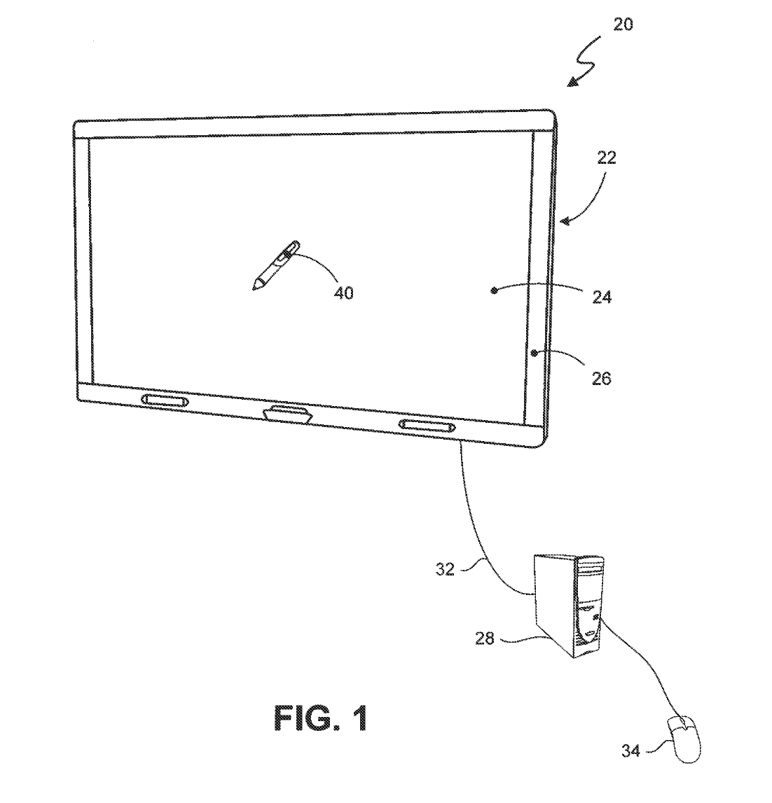

Turning now to FIG. 1, an interactive input system that allows a user to inject input such as digital ink, mouse events etc. into an executing application program is shown and is generally identified by reference numeral 20. In this embodiment, interactive input system 20 comprises an interactive board 22 mounted on a vertical support surface such as for example, a wall surface or the like or otherwise suspended or supported in an upright orientation. Interactive board 22 comprises a generally planar, rectangular interactive surface 24 that is surrounded about its periphery by a bezel 26. An image, such as for example a computer desktop is displayed on the interactive surface 24. In this embodiment, a liquid crystal display (LCD) panel or other suitable display device displays the image, the display surface of which defines interactive surface 24.

The interactive board 22 employs machine vision to detect one or more pointers brought into a region of interest in proximity with the interactive surface 24. The interactive board 22 communicates with a general purpose computing device 28 executing one or more application programs via a universal serial bus (USB) cable 32 or other suitable wired or wireless communication link. General purpose computing device 28 processes the output of the interactive board 22 and adjusts image data that is output to the interactive board 22, if required, so that the image presented on the interactive surface 24 reflects pointer activity. In this manner, the interactive board 22 and general purpose computing device 28 allow pointer activity proximate to the interactive surface 24 to be recorded as writing or drawing or used to control execution of one or more application programs executed by the general purpose computing device 28.

Imaging assemblies (not shown) are accommodated by the bezel 26, with each imaging assembly being positioned adjacent a different corner of the bezel. Each imaging assembly comprises an image sensor and associated lens assembly that provides the image sensor with a field of view sufficiently large as to encompass the entire interactive surface 24. A digital signal processor (DSP) or other suitable processing device sends clock signals to the image sensor causing the image sensor to capture image frames at the desired frame rate. The imaging assemblies are oriented so that their fields of view overlap and look generally across the entire interactive surface 24. In this manner, any pointer such as for example a user's finger, a cylinder or other suitable object, a pen tool 40 or an eraser tool that is brought into proximity of the interactive surface 24 appears in the fields of view of the imaging assemblies and thus, is captured in image frames acquired by multiple imaging assemblies.

When the imaging assemblies acquire image frames in which a pointer exists, the imaging assemblies convey the image frames to a master controller. The master controller in turn processes the image frames to determine the position of the pointer in (x,y) coordinates relative to the interactive surface 24 using triangulation. The pointer coordinates are then conveyed to the general purpose computing device 28 which uses the pointer coordinates to update the image displayed on the interactive surface 24 if appropriate. Pointer contacts on the interactive surface 24 can therefore be recorded as writing or drawing or used to control execution of application programs running on the general purpose computing device 28.

The general purpose computing device 28 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computing device components to the processing unit. The general purpose computing device 28 may also comprise networking capability using Ethernet, WiFi, and/or other network format, for connection to access shared or remote drives, one or more networked computers, or other networked devices. The general purpose computing device 28 is also connected to the world wide web via the Internet.

The interactive input system 20 is able to detect passive pointers such as for example, a user's finger, a cylinder or other suitable objects as well as passive and active pen tools 40 that are brought into proximity with the interactive surface 24 and within the fields of view of imaging assemblies. The user may also enter input or give commands through a mouse 34 or a keyboard (not shown) connected to the general purpose computing device 28. Other input techniques such as voice or gesture-based commands may also be used for user interaction with the interactive input system 20.

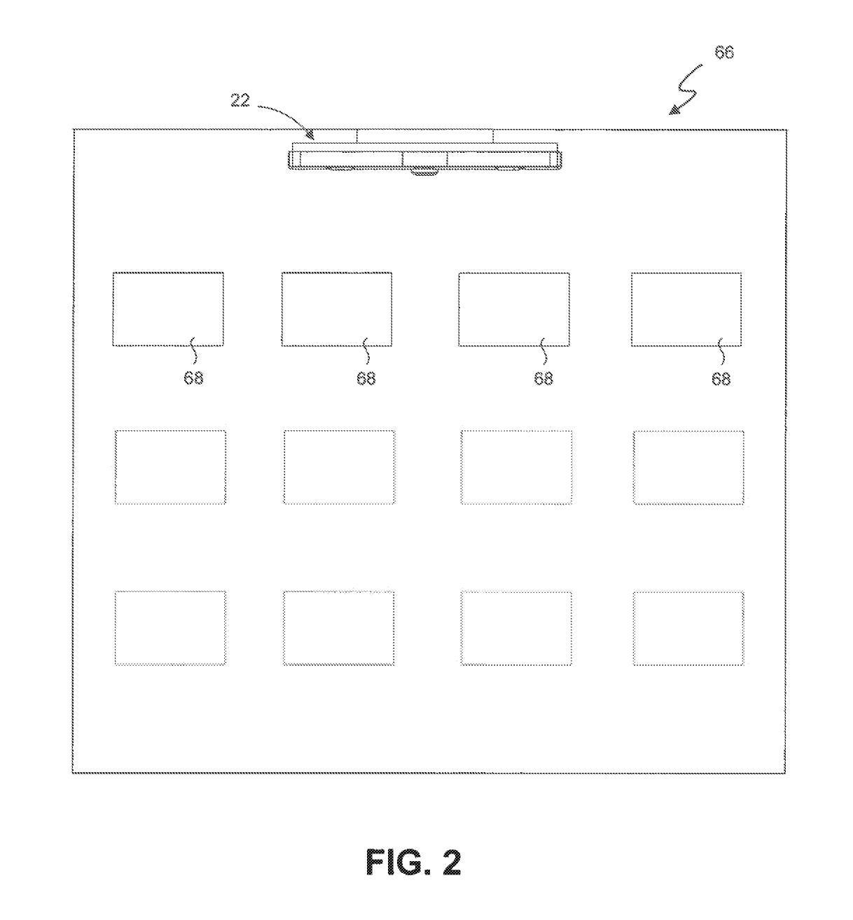

As shown in FIG. 2, interactive board 22 may operate in an operating environment 66 in which one or more fixtures 68 are located. In this embodiment, the operating environment 60 is a classroom and the fixtures 68 are desks, however, as will be understood, interactive board 22 may alternatively be used in other environments.

The general purpose computing device 28 is configured to run an Internet browser application that allows the general purpose computing device 28 to be connected to a remote host server (not shown) hosting an Internet website and running a collaboration application.

The collaboration application allows a collaboration session for one or more computing devices connected to the remote host server via Internet connection to be established. Different types of computing devices may connect to the remote host server to join the collaboration session such as, for example, the general purpose computing device 28, laptop computers, tablet computers, desktop computers, and other computing devices such as for example smartphones and PDAs. One or more participants can join the collaboration session by connecting their respective computing devices to the remote website via Internet browser applications running thereon. Participants of the collaboration session can all be located in the operating environment 66, or can alternatively be located at different sites. It will be understood that the computing devices may run any operating system such as Microsoft Windows™, Apple iOS, Linux, etc., and therefore the Internet browser applications running on the computing devices are also configured to run on these various operating systems.

When a computing device user wishes to join the collaborative session, the Internet browser application running on the computing device is launched and the address (such as a uniform resource locator (URL)) of the website running the collaboration application on the remote host server is entered resulting in a collaborative session join request being sent to the remote host computer. In response, the remote host server returns HTML5 code to the computing device. The Internet browser application launched on the computing device in turn parses and executes the received code to display a shared two-dimensional workspace of the collaboration application within a window provided by the Internet browser application. The Internet browser application also displays functional menu items and buttons etc. within the window for selection by the user. Each collaboration session has a unique identifier associated with it, allowing multiple users to remotely connect to the collaboration session using this identification. This identifier forms part of the URL address of the collaboration session. For example, the URL “canvas.smartlabs.mobi/default.cshtml?c=270” identifies a collaboration session that has an identifier 270.

The collaboration application communicates with each computing device joined to the collaboration session, and shares content of the collaboration session therewith. During the collaboration session, the collaboration application provides the two-dimensional workspace, referred to herein as a canvas, onto which input may be made by participants of the collaboration session. The canvas is shared by all computing devices joined to the collaboration session.

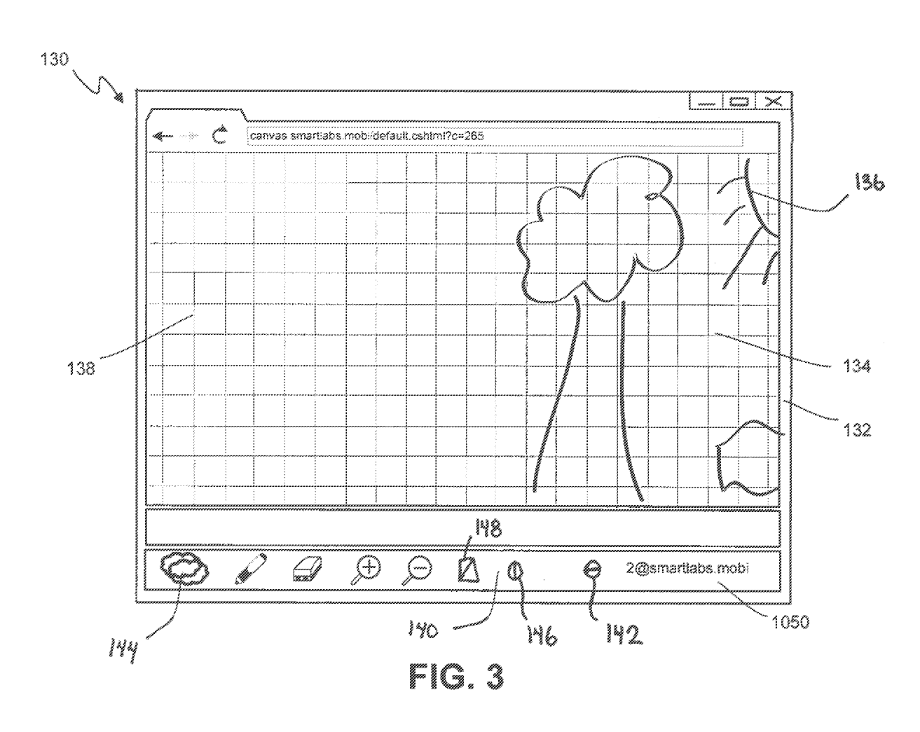

FIG. 3 shows an exemplary Internet browser application window displayed on the interactive surface 24 when the general purpose computing device 28 connects to the collaboration session, and which is generally referred to using reference numeral 130. Internet browser application window 130 comprises an input area 132 in which the canvas 134 is displayed. The canvas 134 is configured to be extended in size within its two-dimensional plane to accommodate new input as needed during the collaboration session. As will be understood, the ability of the canvas 134 to be extended in size within the two-dimensional plane as needed causes the canvas to appear to be generally infinite in size. In the example shown in FIG. 3, the canvas 134 has input thereon in the form of digital ink 136. The canvas 134 also comprises a reference grid 138, over which the digital ink 136 is applied. The Internet browser application window 130 also comprises a menu bar 140 providing a plurality of selectable icons, with each icon providing a respective function or group of functions.

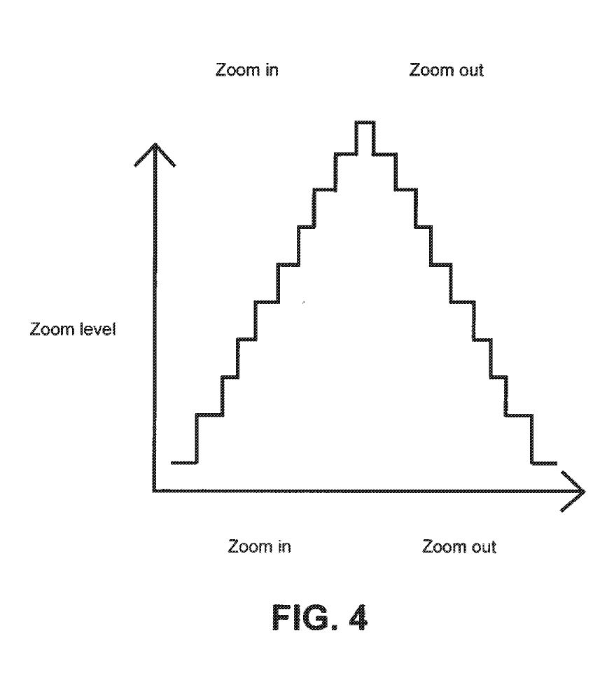

The collaboration application displays the canvas 134 within the Internet browser application window 130 at a zoom level that is selectable by a participant via a zoom command. In this embodiment, the collaboration application displays the canvas 134 at any of ten (10) discrete zoom levels. FIG. 4 shows the ten (10) discrete zoom levels at which the canvas 134 may be displayed. The collaboration application allows a participant to input gestures to manipulate the canvas 134 and content thereon. For example, a participant can apply two fingers on the canvas 134 and then move the fingers apart to input a “zoom in” gesture and invoke a zoom command. During zooming, the collaboration application displays the zooming of the canvas 134 according to a continuous zoom scale. However, at the end of the zoom command, and namely upon release of the fingers from the canvas 134, the collaboration application is configured to “snap” the zoomed canvas 134 to a nearest one of the discrete zoom levels via a smooth animation.

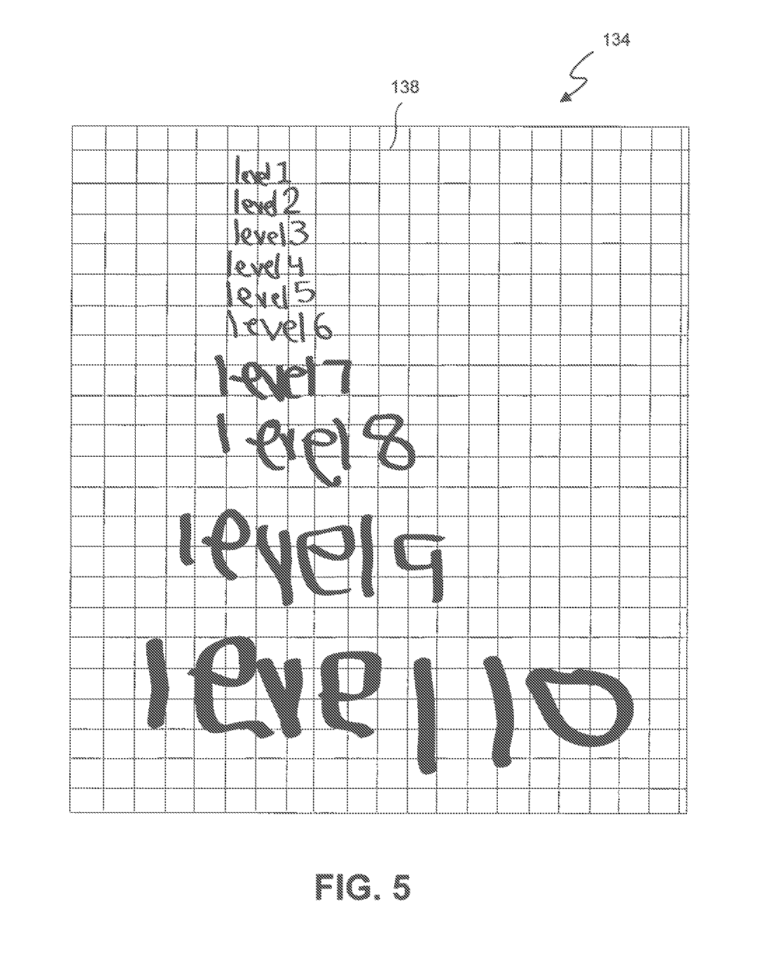

The collaboration application is configured to display all new digital ink input on the canvas 134 at a fixed line thickness with respect to the display associated with the general purpose computing device 28, regardless of the current zoom level of the canvas 134. FIG. 5 shows the line thicknesses associated with each of the ten (10) discrete zoom levels of the canvas 134. When the zoom level of the canvas 134 is changed, the collaboration application adjusts the grid spacing and the line thickness of all digital ink in the canvas 134 in accordance with the new zoom level, and redisplays the adjusted grid 138 and the adjusted digital ink accordingly. As will be understood, the use of a single and fixed line thickness for all new digital ink input advantageously enables participants to easily determine the zoom level at which input was made simply by viewing the line thickness of that digital ink input.

A participant can change the view of the canvas 134 through pointer interaction therewith. For example, the collaboration application, in response to one finger held down on the canvas 134, pans the canvas 134 continuously. The collaboration application is also able to recognize a “flicking” gesture, namely movement of a finger in a quick sliding motion over the canvas 134. The collaboration application, in response to the flicking gesture, causes the canvas 134 to be smoothly moved to a new view displayed within the Internet browser application window 130.

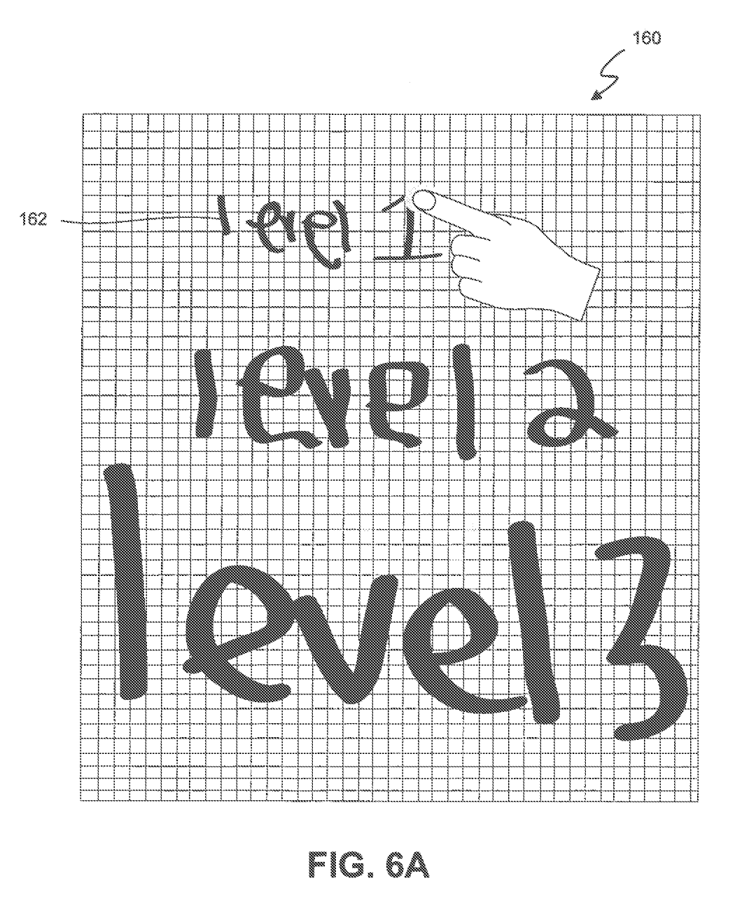

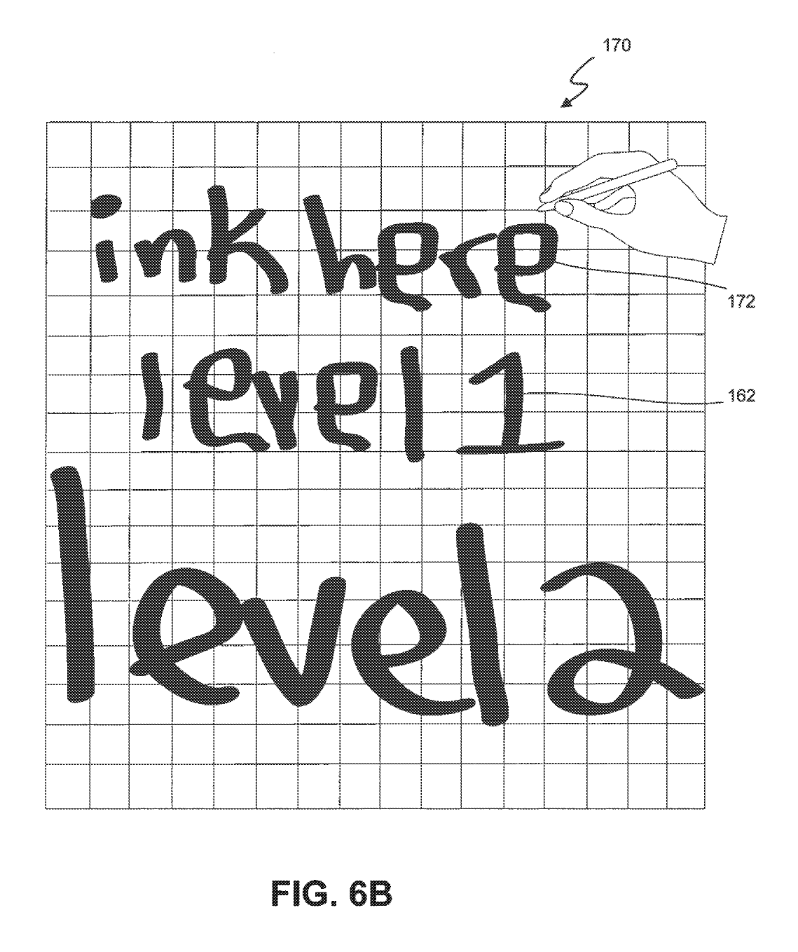

The collaboration application enables participants to easily return to a previous zoom level using a double-tapping gesture, namely a double tapping of a finger, within the input area 132. FIG. 6A shows a double-tapping gesture being made on digital ink 162 that was input at zoom level 3. In response to the double-tapping gesture, the collaboration application displays a transition of the canvas 134 from its current zoom level to zoom level 1. At low zoom levels, the canvas 134 is zoomed out, resulting in a greater portion of the canvas being displayed within the input area 132. At high zoom levels, the canvas is zoomed in, resulting in a lesser portion of the canvas being displayed within the input area 132. The collaboration application adjusts the grid spacing and the line thickness of all digital ink in the canvas 134 in accordance with the new zoom level, and redisplays the adjusted grid 138 and the adjusted digital ink and accordingly. After the transition, the collaboration application zooms in to the new zoom level, and the displayed line thickness of existing digital ink increases correspondingly. The displayed spacing of grid 138 also increases correspondingly. New digital ink 172 is injected on the canvas 134 at the fixed line thickness with respect to the display associated with the general purpose computing device 28, as shown in FIG. 6B.

During the collaboration session, for each computing device joined to the collaboration session, the collaboration application monitors the view of the canvas 134 displayed within the Internet browser application window 130 presented thereby. At any of the computing devices, if a view of the canvas 134 is displayed for a time longer than a dwell time threshold, the collaboration application saves the current view as a favourite view of the collaboration session. In particular, the center position and the zoom level of the current view are stored in storage (not shown) that is in communication with the remote host server running the collaboration application. In this embodiment, the dwell time threshold is twenty (20) seconds. The collaboration application is also configured to save a view count for each saved favourite view.

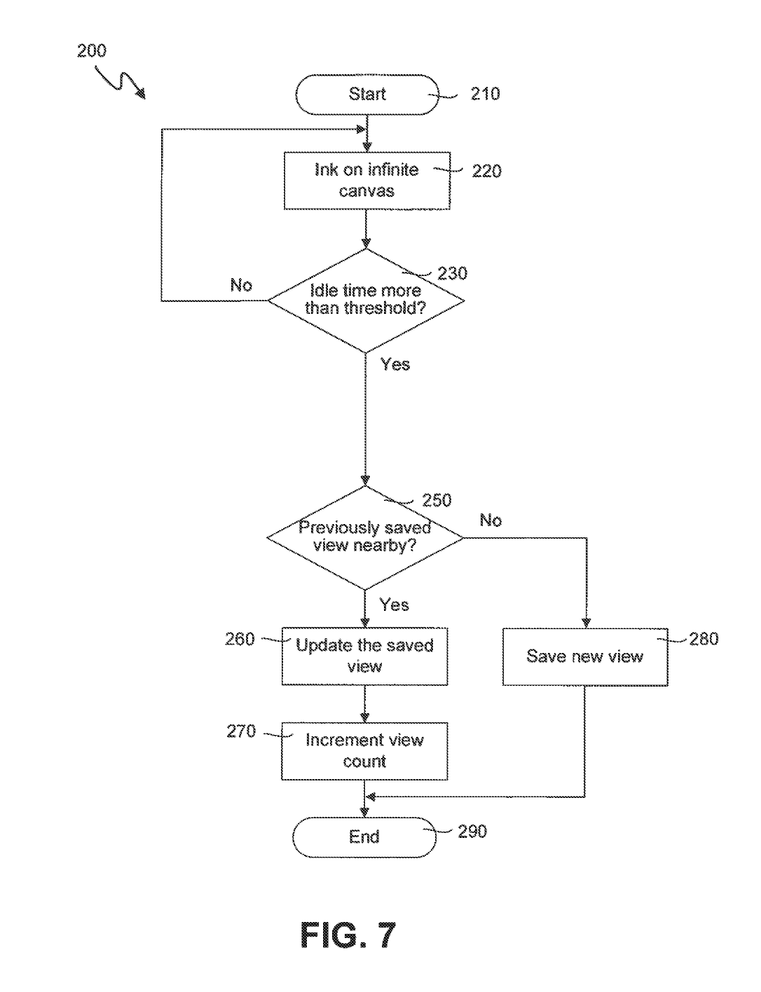

For each of the computing devices joined to the collaboration session, the collaboration application is configured to update the view of the canvas 134 displayed within the Internet browser application window 130 according to a view update process, which is shown in FIG. 7 and generally indicated by reference numeral 200. Process 200 starts when the collaboration session is initiated (step 210). During the collaboration session, the collaboration application receives gestures, such as move gestures and zoom gestures, and input in the form of digital ink injected onto the canvas 134 (step 220) from one or more computing devices joined to the collaboration session. Following receipt of a gesture or input of digital ink from a computing device, the collaboration application starts an idle timer and continuously checks if the idle time value exceeds the dwell time threshold (step 230). If at step 230, the idle time value does not exceed the dwell time threshold, then the process returns to step 220 and awaits a gesture or digital ink input. If at step 230, the idle time value exceeds the dwell time threshold, then the collaboration application searches for a saved favourite view at the current zoom level having a center location that is within a predefined distance of the center location of the current view (step 250). In this embodiment, the predefined distance is 0.8 times the length of the input area 132 of the Internet browser application window 130 in which the canvas 134 is displayed. If a nearby favourite view is found at step 250, then the collaboration application updates the view of the canvas 134, whereby the canvas 134 is displayed within the Internet browser application window 130 such that it is centered on an average of the center positions of the current view and the favourite view (step 260). The view count of the favourite view is then incremented by a value of one (1) (step 270). If at step 250, a nearby favourite view is not found, then the collaboration application saves the current view as a favourite view of the collaboration session (step 280). The process then ends (step 290).

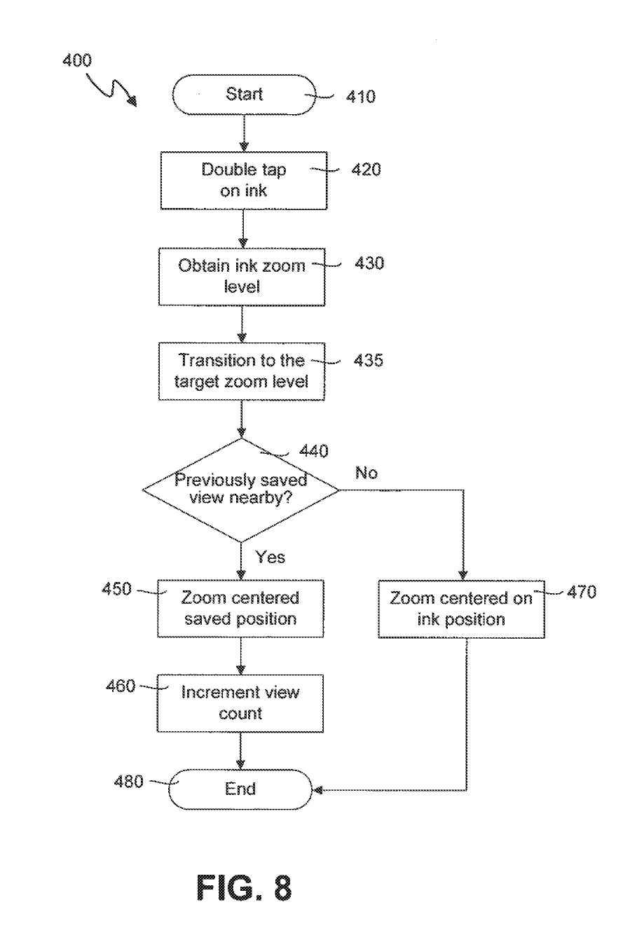

When the zoom level of the canvas 134 is changed, the collaboration application is configured to snap the current view of the canvas 134 to a nearby favourite view at that zoom level, if one is available. FIG. 8 illustrates a canvas view snap process used by the collaboration application, and which is generally indicated using reference numeral 400. Process 400 starts when the collaboration session is initiated (step 410). Upon receiving a double-tapping command on digital ink (step 420) from a computing device, the collaboration application identifies the line thickness of the digital ink, and then determines the desired zoom level (step 430). The collaboration application then displays a smooth transition of the canvas 134 to the new zoom level (step 435). The collaboration application then searches for a saved favourite view at the new zoom level having a center location that is within the predefined distance of the center location of the current view (step 440). If a saved favourite view is found at step 440, then the collaboration application updates the view of the canvas 134, whereby the canvas 134 is displayed such that it is centered on an average of the center positions of the current view and the favourite view (step 450). The view count of the favourite view is then incremented by a value of one (1) (step 460). If at step 440, a saved favourite view is not found, then the canvas 134 is displayed within the Internet browser application window 130 at the current position (step 470). The process then ends (step 480).

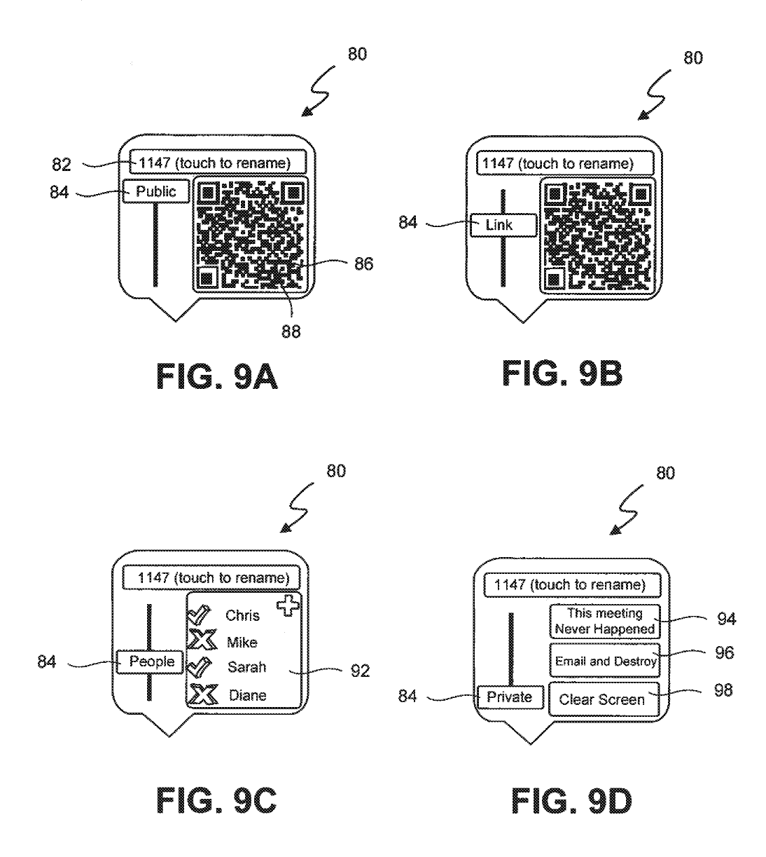

The menu bar 140 of the Internet browser application window 130 comprises a privacy icon 142, which may be selected by a participant to perform various privacy-related tasks relating to the collaboration session. Upon selection of the privacy icon 142, the collaboration application displays a privacy level dialogue box within the Internet browser application window 130 and adjacent the privacy icon 142. FIGS. 9A to 9D show the privacy level dialogue box, which is generally indicated by reference numeral 80. The privacy level dialogue box 80 comprises an identifier field 82 in which an identifier of the collaboration session is displayed. In the examples shown in FIGS. 9A to 9D, the collaboration session is named “1147”. Privacy level dialogue box 80 also comprises a slider 84 that can be moved to various settings to set the privacy level of the collaboration session. In this embodiment, the settings available are “public”, “link”, “people” and “private”. The slider 84 comprises a display field 86 in which the privacy level of the current setting is displayed.

In the example shown in FIG. 9A, the slider 84 is set to the “public” setting. A collaboration session having a “public” privacy level is viewable and searchable by the public. In this embodiment, the “public” default privacy level is used for all new collaboration sessions. When the slider 84 is set to the “public” setting, the remote host server generates a graphic representation of a link to the collaboration session, and displays the graphic representation in the display field 86. In the embodiment shown, the representation is a quick response (QR) code 88 encoding the link to the collaboration session. The QR code 88 allows a person who is in the vicinity of the displayed QR code 88 and who is using a respective computing device equipped with a camera, such as for example a smartphone or a tablet, to easily join the collaboration session by scanning the QR code 88 using the camera. As will be understood, an image processing application running on the camera-equipped computing device then automatically decodes the scanned QR code 88, launches the Internet browser application and directs it to the website of the collaboration session using the link represented by the QR code 88, resulting in the computing device joining the collaboration session.

In the example shown in FIG. 9B, the slider 84 is set to the “link” setting. A collaboration session having a “link” privacy level is accessible only upon entry of the identifier of the URL address of the collaboration session in an address bar of the Internet browser application window 130. When the slider 84 is set to the “link” privacy level, the remote host server generates a QR code 88 encoding the link to the collaboration session and displays it within the display field 86 of the privacy level dialogue box 80.

In the example shown in FIG. 9C, the slider 84 is set to the “people” setting. A collaboration session having a “people” privacy level may be accessed only by participants listed in a list 92 of collaboration session participants. When the slider 84 is set to the “people” privacy level, the list 92 of participants is displayed within the display field 86 of the privacy level dialogue box 80. The list 92 of participants may be created manually or may be created automatically based on predefined rules. As an example, for an existing collaboration session, participants who contributed to the collaboration session by injecting digital ink input or by sending documents through email, are added to the list 92 of participants, and may therefore access this collaboration session at a later date.

In the example shown in FIG. 9D, the slider 84 is set to the “private” setting. At this setting, a plurality of buttons 94 to 98 is displayed within the display field 86 of the privacy level dialogue box 80. Selection of button 94, which in the example shown is labelled “this meeting never happened”, causes the collaboration application to delete the collaboration session. Selection of button 96, which in the example shown is labelled “email and destroy”, causes the collaboration application to email contents of the collaboration session to all collaboration session participants, and then to delete the collaboration session. In this embodiment, the contents of the collaboration session comprise all content on the canvas 134 and all files attached to the collaboration session. Selection of button 98, which in the embodiment shown is labelled “clear screen”, causes the collaboration application to delete all content on the canvas 134.

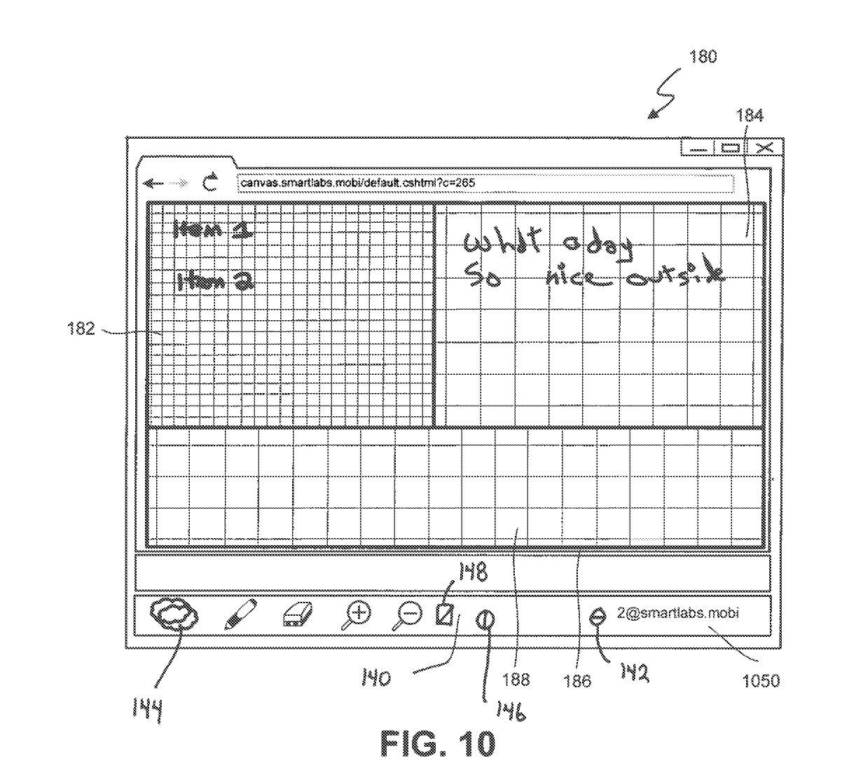

The menu bar 140 of the Internet browser application window 130 comprises a split screen icon 144, which may be selected by a participant to display different views of the canvas 134 simultaneously within a split screen display area of the Internet browser application window. FIG. 10 illustrates the Internet browser application window 130 updated to show the split screen display area, which is generally referred to using reference numeral 180. Split screen display area 180 comprises a first display region 182 and a second display region 184. Each of the display regions 182 and 184 is configured to display a respective view of the canvas 134 at a respective zoom level. A participant may input gestures, such as scroll, pan and zoom gestures on each of the views of the canvas 134 displayed in the first and second display regions 182 and 184 independently, such as for example to compare content existing at different locations of the canvas 134. The split screen display area 180 also comprises a third display region 186, which is configured to display an additional canvas 188. Additional input in the form of digital ink can be injected onto the additional canvas 188. Such additional input may be, for example, notes made by a participant relating to a comparison of content displayed in the first and second display regions 182 and 184. The collaboration application is configured to hide the third display region 186 upon further selection of the split screen icon 142, and to display the third display area 186 upon still further selection of the split screen icon 142. As will be understood, the split screen display area 180 advantageously allows a participant to, for example, converge more quickly on a single solution from two different ideas input separately onto the canvas 134 during the collaboration session.

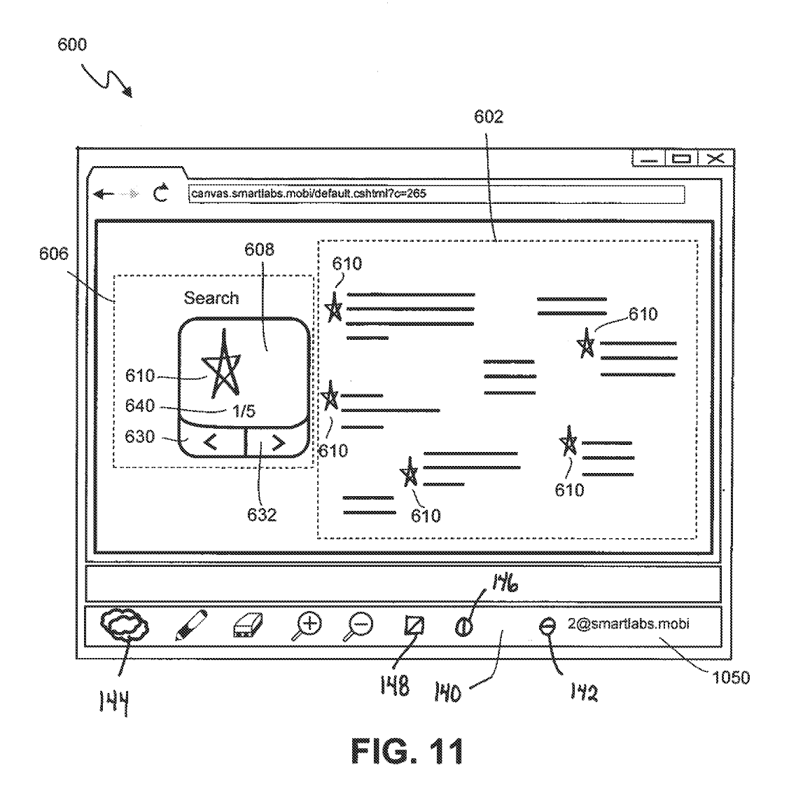

During the collaboration session, participants can annotate input on the canvas 134 with an identifying mark, such as an asterisk, a star, or other symbol. Such marked input may be, for example, an important idea made by a participant. To help participants quickly find this marked input, the menu bar 140 of the Internet browser application window 130 comprises a mark search icon 146 which, when selected, displays a mark search dialogue view within the Internet browser application window. FIG. 11 illustrates the Internet browser application window 130 updated to show the mark search dialogue view, which is generally referred to using reference numeral 600. Mark search dialogue view 600 comprises an area 602 in which a view comprising a union of portions of the canvas 134 in which instances of the searched mark exist. Mark search dialogue view 600 further comprises a mark search dialogue box 606 superimposed on the canvas 134 in the area 602. Mark search dialogue box 606 further comprises an input window 608 in which an identifying mark 610 can be drawn in digital ink. Once the identifying mark 610 has been drawn in the input window 608, the collaboration application locates all instances of the identifying mark 610 within the canvas 134 and highlights these instances on the canvas 134 displayed in area 602. The mark search dialogue box 606 also comprises forward and reverse scroll buttons 630 and 632, respectively, which may be selected to sequentially center the view of the canvas 134 on each of the instances of the identified mark 610. The search dialogue box 608 also comprises an indicator 640 showing the instance of the identifying mark 610 on which the view of the canvas 134 is currently centered. As will be appreciated, the mark search dialogue view 600 advantageously enables a participant to locate and view each instance of marked input in a quick and facile manner.

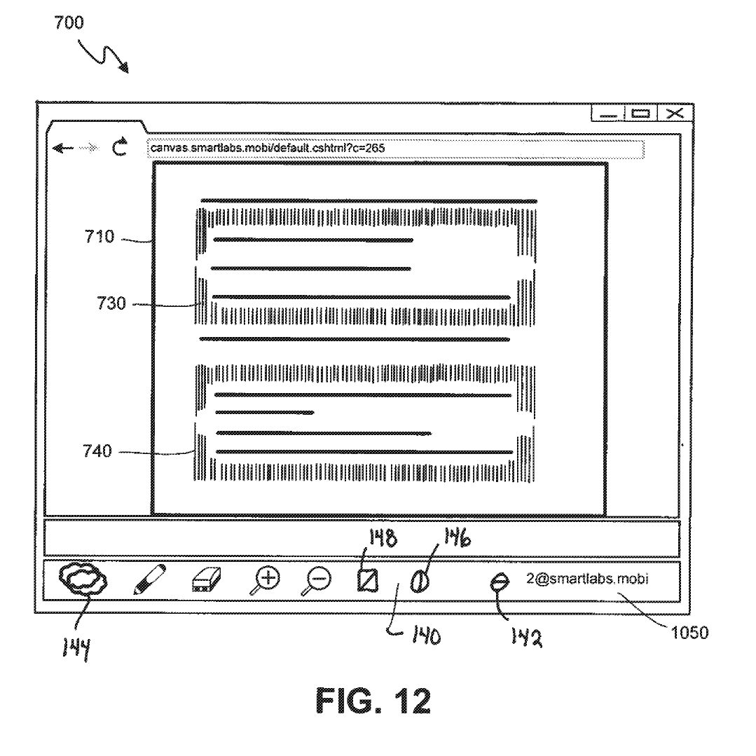

To help participants quickly identify important views of the canvas 134, the menu bar 140 of the Internet browser application window 130 comprises a dwell time icon (not shown) which, when selected, displays a dwell time view within the Internet browser application window 130. FIG. 12 illustrates the Internet browser application window 130 updated to show the dwell time view, which is generally referred to using reference numeral 700. The dwell time view 700 comprises an area 710 in which a view of the entire canvas 134 is displayed. The dwell time view 700 shows one or more halos, with each halo surrounding a respective view of the canvas 134 and having a colour indicative of the dwell time for that view. Halos surrounding favourite views having long dwell times are shown in warm colours (such as red, orange etc.), while halos surrounding views having short dwell times are shown in cold colours (blue, green etc). In the example shown, the dwell time view 700 shows a first halo 730 surrounding a first view of the canvas 134, and a second halo 740 surrounding a second view of the canvas 134. As the dwell time of the first view is long, the first halo 730 is shown in a warm colour (not shown). The dwell time of the second view is short, and as a result the second halo 740 is shown in a cold colour (not shown).

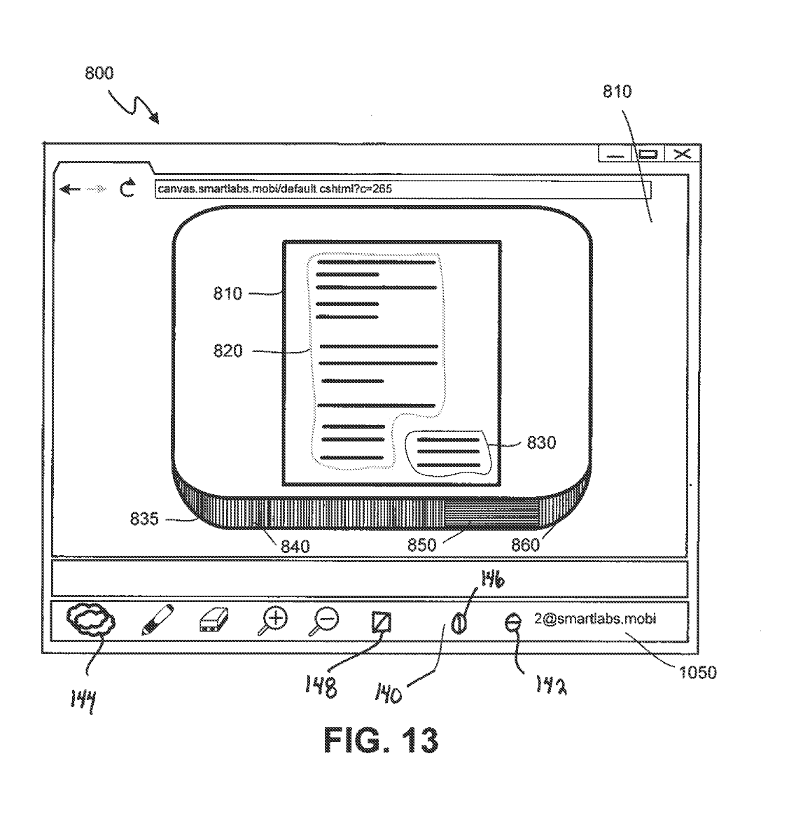

The collaboration application is configured to identify each participant participating in the collaboration session according to his/her login identification, and to monitor input contribution made by each participant during the collaboration session. The input contribution may include any of, for example, the quantity of digital ink input onto the canvas 134 and the quantity of image data, audio data (such as the length of the voice) and video data (such as the length of the video) input onto the canvas 134, as well as the content of voice input added by a participant to the collaboration session. To allow the relative input contributions of the participants to be readily identified, the menu bar 140 of the Internet browser application window 130 comprises a contribution input button 148. Selection of the contribution input button 148 displays a contribution input view within the Internet browser application window 130. FIG. 13 illustrates the Internet browser application window 130 updated to show the contribution input view, which is generally referred to using reference numeral 800. The contribution input view 800 comprises an area 810 in which a view of the entire canvas 134 is displayed. The contribution input view 800 shows the digital ink input of each participant as highlighted by a different respective color. In the example shown, digital ink input 820 of a first participant is highlighted by a first colour (not shown), and digital ink input 830 of a second participant is highlighted by a second colour (not shown). The contribution input view 800 also comprises a contribution graph 835, in which the relative contribution input of each participant is indicated by a graph portion drawn in the same colour as that used to highlight that participant's digital ink input on the canvas 134. In the example shown, the first participant contributed more digital ink than the second participant. As a result, the graph portion 840 of the first participant appears commensurately larger in the contribution graph 835 than the graph portion 850 of the second participant. In the example shown, a third participant also participated in the collaboration session, but only contributed voice input during the collaboration session and did not input any digital ink onto the canvas 134. Accordingly, a graph portion 860 indicating a relative quantity of this voice input contribution of the third user is also shown in the contribution graph 835. As will be appreciated, the contribution input view 800 advantageously allows the input contribution for participants of the collaboration session to be quickly identified. Input contribution visualization is particularly useful for collaboration sessions in academic environments, in which teachers are typically interested in knowing the contribution of each student during a collaboration session, such as for example a group project. Use of the contribution input view 800 allows the teacher to quickly and easily view the contribution that each student made to the group project.

The collaboration application is configured to automatically generate and assign an electronic mail (email) address to the collaboration session. In the example shown in FIG. 3, the collaboration application has assigned the email address 2@smartlabs.mobi to the collaboration session. The assigned email address is displayed in an email field 1050 within the Internet browser application window 130.

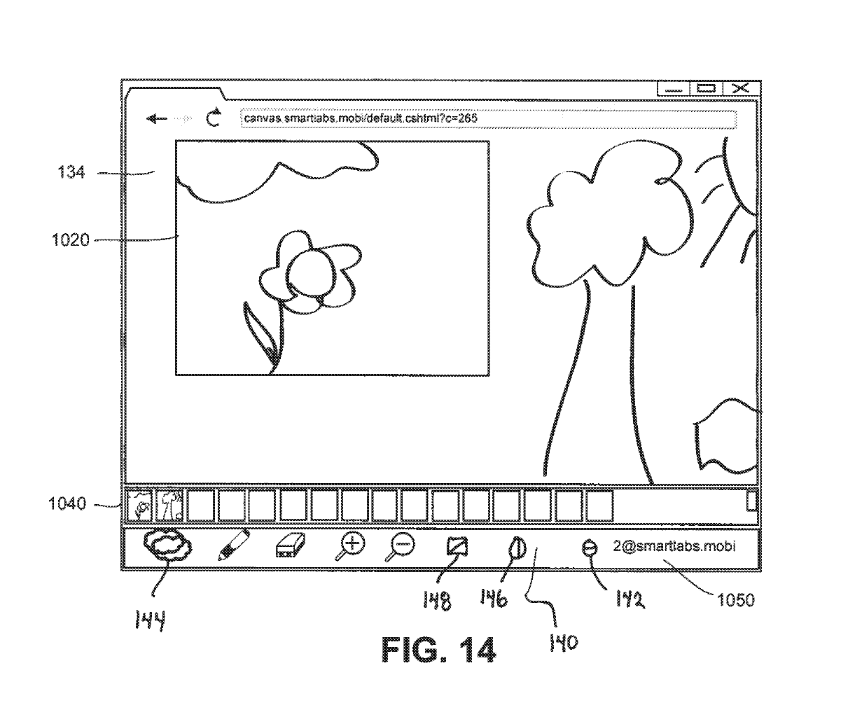

The collaboration application is configured to receive one or more emails sent by collaboration session participants to the assigned email address, and to associate such emails with the collaboration session. Such emails may comprise one or more attached documents, such as for example, an image file, a pdf file, a scanned handwritten note, etc. When such an email is received, the collaboration application displays the content of the email, and any attached document, as one or more thumbnail images in a queue area within the Internet browser application window 130. FIG. 14 illustrates the Internet browser application window 130 updated to show the queue area 1040. Each thumbnail image displayed in the queue area 1040 is marked with the name (not shown) of the participant by whom the email was sent. The collaboration application is configured to allow participants to continue using the canvas 134 without being interrupted by a received email, and without being interrupted by the display of the content of the received email in the queue area 1040.

The collaboration application allows participants to drag and drop content displayed in the queue area 1040 onto the canvas 134. In the example shown in FIG. 14, the queue area 1040 comprises thumbnail images representing two image files received in emails from participants. One of the images has been dragged and dropped onto the canvas 134 as a “sticky note” image 1020. The sticky note image 1020 may be moved to a different location on the canvas 134 after being dropped thereon, as desired. The collaboration application displays the image appearing in the sticky note image 1020 at the native resolution of the corresponding image file received in the email regardless of the zoom level. However, the sticky note image 1020 may be resized to a different size, as desired. It should be noted that the collaboration application does not allow moving or resizing of ink input on the canvas 134. Rather, participants may move or zoom the canvas 134 to effectively move or resize digital ink input displayed thereon.

At the end of a collaboration session, the collaboration application is configured to automatically save the content of the collaboration session to cloud based storage. A participant may find the contents of a previous collaboration session by following a unique URL for that collaboration session. The unique URL for the collaboration session is emailed to all participants of the collaboration session. By default, all participants who have sent content to the collaboration session by email are considered as participants and they are automatically sent a URL link to the collaboration session. Additionally, all the participants who annotate digital ink on the canvas 134 are sent the URL link to the collaboration session.

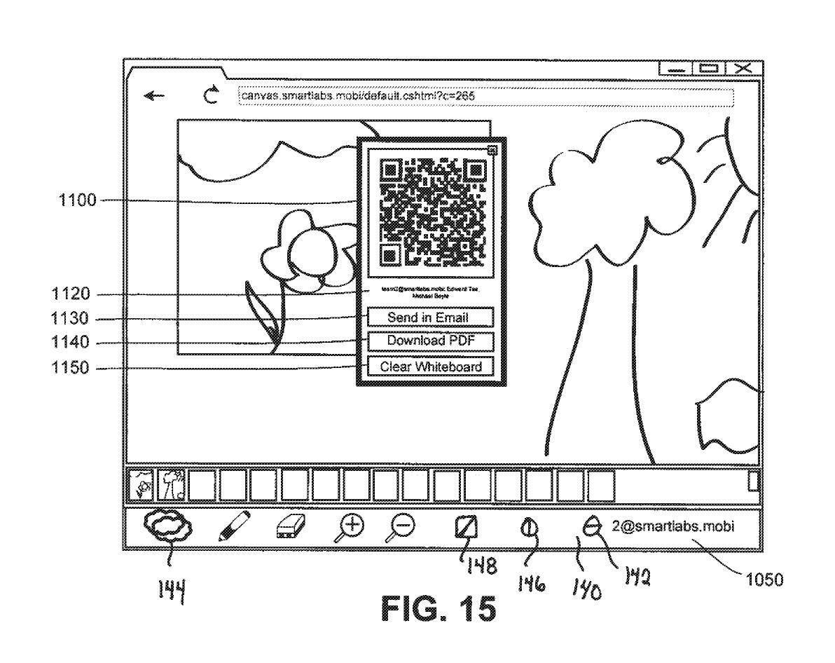

At the end of the collaboration session, the collaboration application is configured to display a user interface dialog box within the display area 132 of the Internet browser application window 130. FIG. 15 illustrates the Internet browser application window 130 updated to show the user interface dialogue box, which is generally referred to using reference numeral 1100. The user interface dialog box 1100 comprises a list 1120 of the participants of the collaboration session. The user interface dialog box 1100 also comprises a plurality of buttons 1130, 1140 and 1150 that may be selected by a participant. Selection of button 1130, which in the example shown is labelled “send in email”, causes the collaboration application to send an email to all of the participants of the collaboration session. Selection of button 1140, which in the example shown is labelled “download pdf”, causes the collaboration application to download the content of the collaboration session to the respective computing device of the participant. The collaboration application converts the content on the canvas including ink annotations, pictures etc. by dividing the annotated area into pages based on the size of the view at the default zoom level and then converting the pages to a pdf file. Selection of button 1150, which in the example shown is labelled “clear whiteboard”, causes the collaboration application to delete all content from the canvas 134.

The collaboration application creates a group email address containing the email addresses of the participants of a collaboration session. In the example shown in FIG. 15, for which the collaboration session has assigned the email address “2@smartlabs.mobi” to the canvas 134, the collaboration application creates the group email address team2@smartlabs.mobi. The group email address contains the email addresses of all participants of the collaboration session. As will be understood, use of a single address generally facilitates communication between participants of the collaboration session, and eliminates the need for participants to, for example, remember the names and/or email addresses of the other participants. The collaboration application is configured to forward any email sent to the group email address of the collaboration session to all of participant email addresses associated with that group email address.

During the course of email communication new participants can be included by manually adding their email addresses in the “cc” field when sending an email to the group email address. The collaboration application is configured to automatically add email addresses of the participants listed in the “cc” field to the group email address when such an email is sent to the group email address. This allows participants to be added to the group email address as needed. The collaboration application also allows email addresses to be manually removed from the group email address by participants.

The collaboration application is also configured to generate an acronym for the title of the canvas 134. For example, for a collaboration session titled “jill's summer of apples”, the collaboration session will generate an acronym “jsoa”. A user can type “JSOA” into the URL of the collaboration application to obtain the content of the previously saved collaboration session.

The collaboration application allows users to search for previously saved collaboration sessions by date, time or the location of the collaboration session. The search results will be shown on a map. The user can click on the collaboration session that she is interested in and the contents of the collaboration session will be opened.

In an alternative embodiment, the interactive input system comprises sensors for proximity detection. Proximity detection is described for example in International PCT Application Publication No. WO 2012/171110 to Tse et al. entitled “Interactive Input System and Method”, the disclosure of which is incorporated herein by reference in its entirety. Upon detecting users in proximity of the interactive input system 20, the interactive board 22 is turned on and becomes ready to accept input from users. The interactive board 22 presents the user interface of the collaboration application to the user. The user can immediately start working on the canvas 134 without the need for logging in. This embodiment improves the meeting start up by reducing the amount of time required to start the interactive input system 20 and login to the collaboration application. At the end of the collaboration session, the collaboration application will ask the user whether the content of the collaboration session needs to be saved. If the user does not want to save the contents of the collaboration session, the collaboration application will close the collaboration session. Otherwise, the collaboration application prompts the user to enter the login information so that the contents of the collaboration session can be saved to the cloud storage.

Although in embodiments described above the interactive input system is described as utilizing an LCD device for displaying the images, those skilled in the art will appreciate that other types of interactive input systems may be used. For example, an interactive input system that includes a boom assembly to support a short-throw projector such as that sold by SMART Technologies ULC under the name “SMART UX60”, which projects an image, such as for example, a computer desktop, onto the interactive surface 24 may be employed.

In alternative embodiments, different numbers of privacy setting levels than described above and with reference to FIGS. 9A to 9D may be employed and/or different numbers of zoom levels in the collaboration application may be employed.

In an alternative embodiment, the collaboration application searches for previously saved favourite views near the current view across multiple zoom levels.

In an alternative embodiment, a different type of visualization is used to indicate the contribution of various participants in the meeting.

In another alternative embodiment, the collaboration application presents detailed statistical information about the collaboration session such as for example, the number of participants, time duration, number of documents added to the meeting space and contribution levels of each participant, etc.

In an alternative application the remote host server downloads a software application (also known as a plugin) that runs within the browser on the client side i.e., the user's computing device. This application will perform many operations without the need for communication with the remote host server.

In another alternative embodiment the collaboration application is implemented as a standalone application running on the user's computing device. The user gives a command (such as by clicking an icon) to start the collaboration application. The application collaboration starts and connects to the remote host server by following the pre-defined address of the server. The application displays the canvas to the user along with the functionality accessible through buttons or menu items.

Although embodiments have been described above with reference to the accompanying drawings, those of skill in the art will appreciate that variations and modifications may be made without departing from the scope thereof as defined by the appended claims.

What is claimed is:

1. A method of displaying input during a collaboration session, comprising:
providing a canvas for receiving input from at least one participant using a computing device joined to the collaboration session; and
displaying the canvas at one of a plurality of discrete zoom levels on a display associated with the computing device.

2. The method of claim 1, wherein the input is touch input in the form of digital ink.

3. The method of claim 2, further comprising:
displaying new digital ink input on the canvas at a fixed line thickness with respect to the display associated with the computing device, regardless of the current zoom level of the canvas.

4. The method of claim 1, further comprising:
displaying the canvas at another of said discrete zoom levels in response to a zoom command.

5. The method of claim 4, wherein the zoom command is invoked in response to an input zoom gesture.

6. The method of claim 4, wherein zooming of the canvas is displayed according to a continuous zoom level scale during the zoom command.

7. The method of claim 4, further comprising:
adjusting the line thickness of digital ink displayed in the canvas to said another discrete zoom level.

8. The method of claim 1, further comprising:
displaying the canvas at another of said discrete zoom levels in response to a digital ink selection command.

9. The method of claim 8, wherein the digital ink selection command is invoked in response to an input double-tapping gesture.

10. The method of claim 9, wherein said another discrete zoom level is a zoom level at which the selected digital ink was input onto the canvas.

11. The method of claim 8, further comprising:
searching for a saved favourite view of said canvas that is near a current view of said canvas; and
displaying the canvas such that it is centered on an average center position of the current view and the favourite view.

12. The method of claim 1, wherein said displaying comprises displaying at least one view of the canvas at a respective discrete zoom level.

13. The method of claim 13, wherein said at least one view comprises a plurality of views, the method further comprising displaying said plurality of views of the canvas simultaneously on the display associated with the computing device.

14. The method of claim 1, wherein the collaboration session runs on a remote host server.

15. The method of claim 14, wherein the collaboration session is accessible via an Internet browser application running on the computing device in communication with said remote host server.

16. The method of claim 15, wherein said displaying further comprises displaying the canvas within an Internet browser application window on said display associated with the computing device.

17. An interactive board configured to communicate with a collaboration application running a collaboration session that provides a canvas for receiving input from participants, said interactive board being configured to, during said collaboration session:
receive input from at least one of said participants; and
display the canvas at one of a plurality of discrete zoom levels.

18. The interactive board of claim 17, wherein the input is touch input in the form of digital ink.

19. The interactive board of claim 18, wherein said interactive board is further configured to:
display new digital ink input on the canvas at a fixed line thickness with respect to said interactive board, regardless of the current zoom level of the canvas.

20. The interactive board of claim 17, wherein said interactive board is further configured to:
display the canvas at another of said discrete zoom levels in response to a zoom command.

21. The interactive board of claim 20, wherein the zoom command is invoked in response to an input zoom gesture.

22. The interactive board of claim 19, wherein zooming of the canvas is displayed according to a continuous zoom level scale during the zoom command.

23. The interactive board of claim 19, wherein said interactive board is further configured to:
adjust the line thickness of digital ink displayed on the canvas to said another discrete zoom level.

24. The interactive board of claim 17, wherein said interactive board is further configured to:
display the canvas at another of said discrete zoom levels in response to a digital ink selection command.

25. The interactive board of claim 24, wherein the digital ink selection command is invoked in response to an input double-tapping gesture.

26. The interactive board of claim 25, wherein said another discrete zoom level is a zoom level at which the selected digital ink was input onto the canvas.

27. The interactive board of claim 24, wherein said interactive board is further configured to:
display the canvas such that it is centered on an average center position of a favourite view of said canvas that is near a current view of said canvas.

28. The interactive board of claim 17, wherein said interactive board is further configured to display a plurality of views of the canvas simultaneously, each of said plurality of views being displayed at a respective discrete zoom level.

29. The interactive board of claim 17, wherein said interactive board is configured to communicate with a remote host server running the collaboration application.

30. The interactive board of claim 29, wherein said interactive board is further configured to access the collaboration session via an Internet browser application running on a general purpose computing device in communication with said interactive board.

31. The interactive board of claim 30, wherein said interactive board is further configured to display an Internet browser application window, in which said canvas is displayed.

32. The interactive board of claim 17, wherein said interactive board is in communication with a general purpose computing device running the collaboration application.

33. The interactive board of claim 32, wherein said interactive board is further configured to display a collaboration program application window, in which said canvas is displayed.
